(19) United States
(12) Patent Application Publication
(10) Pub. No.: US 2019/0034045 A1
(43) Pub. Date: Jan. 31, 2019

(54) PROJECTION METHOD AND PROJECTION SYSTEM

(71) Applicant: Coretronic Corporation, Hsin-Chu (TW)

(72) Inventors: Jui-Chi Chen, Hsin-Chu (TW); Yu-Wen Lo, Hsin-Chu (TW)

(73) Assignee: Coretronic Corporation, Hsin-Chu (TW)

(21) Appl. No.: 16/045,685

(22) Filed: Jul. 25, 2018

(30) Foreign Application Priority Data
Jul. 28, 2017 (CN) 201710628334.7

(51) Int. Cl. G06F 3/0482; G03B 21/14; G03B 21/56

(52) U.S. Cl. CPC G06F 3/0482; G03B 21/56; G03B 21/14

(57) ABSTRACT

A projection method adapted to a projector is provided. The projection method includes: executing an interface editing module by a first electronic device to edit an OSD; storing interface editing data by the first electronic device according to an editing result of the OSD; communicating with the projector by the first electronic device, so as to output the interface editing data to the projector, where the projector sets a first interface module according to the interface editing data; and executing the first interface module by the projector to generate interface image data, and projecting the OSD based on the interface image data. A user may design the OSD with his own style according to his preference and habits. Moreover, a projection system is also provided.

### CROSS-REFERENCE TO RELATED APPLICATION

This application claims the priority benefit of China application serial no. 201710628334.7, filed on Jul. 28, 2017. The entirety of the above-mentioned patent application is hereby incorporated by reference herein and made a part of this specification.

### BACKGROUND OF THE INVENTION

### Field of the Invention

The invention relates to a projection technique, and particularly relates to a projection method and a projection system.

### Description of Related Art

Regarding a conventional display device, when a user presses a function menu key, the display device displays an on-screen display (OSD), and the OSD includes a plurality of function options that may be adjusted by a user. However, option content of the function options in the OSD is generally preset by a manufacturer and cannot be modified or designed by the user. Moreover, the user may only operate the OSD through physical keys of a remote controller or a projector, which results in inconvenience in operation. Therefore, in order to make the OSD of the projector easy for users to edit or design, and to facilitate user operation, embodiments of the invention are provided for solution.

The information disclosed in the “BACKGROUND OF THE INVENTION” section is only for enhancement of understanding of the background of the described technology and therefore it may contain information that does not form the prior art that is already known to a person of ordinary skill in the art. Further, the information disclosed in the “BACKGROUND OF THE INVENTION” section does not mean that one or more problems to be resolved by one or more embodiments of the invention were acknowledged by a person of ordinary skill in the art.

### SUMMARY OF THE INVENTION

The invention is directed to a projection method and a projection system, by which a user is adapted to output a self-defined on-screen display (OSD) to a projector by an external electronic device, such that a menu content of the OSD projected by the projector is determined according to user's requirement or a projection environment. The user is adapted to design the OSD with his own style and an operation method thereof according to his own preference and habits. Finally, a file of the OSD is transmitted to the projector or a mobile device to display the OSD required by the user.

In order to achieve one or a portion of or all of the objects or other objects, an embodiment of the invention provides a projection method adapted to a projector. The projection method includes: executing an interface editing module by a first electronic device, so as to edit an on-screen display; storing interface editing data by the first electronic device according to an editing result of the on-screen display; communicating with the projector by the first electronic device, so as to output the interface editing data to the projector, where the projector sets a first interface module according to the interface editing data; executing the first interface module by the projector to generate interface image data, and projecting the on-screen display based on the interface image data.

In order to achieve one or a portion of or all of the objects or other objects, an embodiment of the invention provides a projection system. The projection system includes a first electronic device and a projector. The first electronic device includes a storage device, a processing device and a transmission module. The storage device is configured to store an interface editing module. The processing device is electrically connected to the storage device, and is configured to execute the interface editing module to edit an on-screen display, and store interface editing data to the storage device according to an editing result of the on-screen display. The transmission module is electrically connected to the processing device, and is configured to output the interface editing data. The projector is communicated with the first electronic device. The projector includes a transmission module, a storage device, a processing device and a projection unit. The transmission module is configured to receive the interface editing data output by the first electronic device. The storage device has a first interface module, and sets the first interface module according to the interface editing data. The processing device is electrically connected to the transmission module and the storage device, and is configured to execute the first interface module to generate interface image data. The projection unit is electrically connected to the processing device, and is configured to project the on-screen display, where the on-screen display is projected according to the interface image data.

In order to achieve one or a portion of or all of the objects or other objects, an embodiment of the invention provides a projector configured to communicate with a first electronic device. The projector includes a transmission module, a storage device, a processing device and a projection unit. The transmission module is configured to receive interface editing data output by the first electronic device. The storage device has a first interface module, and sets the first interface module according to the interface editing data. The processing device is electrically connected to the transmission module and the storage device, and is configured to execute the first interface module to generate interface image data. The projection unit is electrically connected to the processing device, and is configured to project the on-screen display, where the on-screen display is projected according to the interface image data.

According to the above description, the invention provides the projection method and the projection system having a function of editing the on-screen display, so as to provide the user to pre-edit the on-screen display by the electronic device, and output the interface editing data of the edited on-screen display to the projector, such that the projector projects the user-defined on-screen display according to the interface editing data.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a projection system according to an embodiment of the invention.

FIG. 2 is a schematic diagram of a projection system according to another embodiment of the invention.

FIG. 3 is a flowchart illustrating a method for editing an on-screen display (OSD) according to an embodiment of the invention.

FIG. 4 is a schematic diagram of an OSD according to an embodiment of the invention.

FIG. 5 is a schematic diagram of an OSD according to another embodiment of the invention.

FIG. 6 is a flowchart illustrating a projection method according to an embodiment of the invention.

### DESCRIPTION OF EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

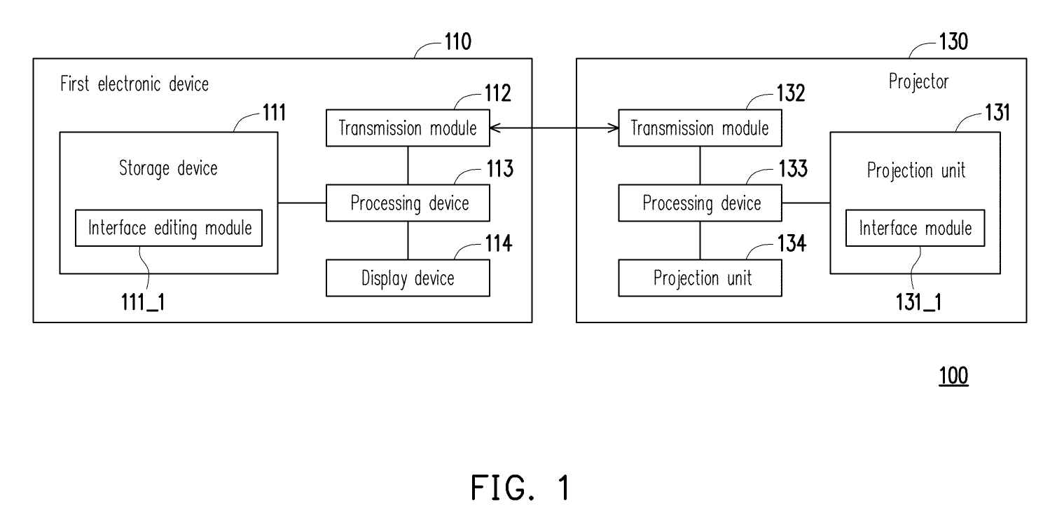

FIG. 1 is a schematic diagram of a projection system according to an embodiment of the invention. Referring to FIG. 1, in the embodiment, the projection system 100 includes a first electronic device 110 and a projector 130. The first electronic device 110 includes a storage device 111, a transmission module 112, a processing device 113 and a display device 114. The projector 130 includes a storage device 131, a transmission module 132, a processing device 133 and a projection unit 134. In the embodiment, the first electronic device 110 is, for example, a desktop computer, a personal computer (PC), a portable terminal product, a personal digital assistor (PDA) or a smart phone, etc. In the embodiment, the first electronic device 110 is connected to the projector 130 for communication through the transmission module 112 and the transmission module 132, for example, to transfer image signals, control signals, data files, etc. between the first electronic device 11 and the projector 130.

In the embodiment, the processing device 113 of the first electronic device 110 is coupled to the storage device 111. The processing device 113 is used for executing a plurality of modules stored in the storage device 111, where the modules include an interface editing module 111_1. The interface editing module 111_1 is, for example, software. In the embodiment, the processing device 113 executes the interface editing module 111_1 to edit an on-screen display (OSD), and the processing device 113 stores interface editing data corresponding to the OSD in a preset encoding manner according to an editing result of the OSD. In the embodiment, the preset encoding manner is, for example, C language, and a data format of the interface editing data is, for example, a binary type image data and a java script object notation (JSON) format text data. In the embodiment, the processing device 113 outputs the interface editing data to the projector 130 through the transmission module 112, and the projector 130 may set an interface module 131_1 according to the interface editing data. The interface module 131_1 is interface generation software built in the projector 130. The interface module 131_1 provides interface image data to the projection unit 134 through the processing device 133, such that the projection unit 134 projects an image of the OSD. In the embodiment, the OSD may display a plurality of function menus related to the projector 130. In detail, the interface module 131_1 may store predetermined interface editing data in the storage device 131, and when the first electronic device 110 transmits the edited interface editing data to the projector 130, the edited interface editing data overwrites the predetermined interface editing data through the interface module 131_1, and the processing device 133 of the projector 130 executes the edited interface editing data.

In the embodiment, the processing device 133 of the projector 130 is coupled to the storage device 131. The processing device 133 is configured to execute a plurality of modules stored in the storage device 131, where the modules include the interface module 131_1. The interface module 131_1 is used for generating the interface image data, and the projection unit 134 of the projector 130 may project an image frame having the OSD according to the interface image data. In the embodiment, after the projector 130 receives the interface editing data through the transmission module 132, the processing device 133 of the projector 130 may set the interface module 131_1 based on the received interface editing data. Therefore, the interface module 131_1 may generate the interface image data corresponding to the interface editing data, and the projection unit 134 projects an image the same with the OSD edited by the first electronic device 110. Moreover, the image of the OSD edited by the first electronic device 110 may also be displayed on the display device 114. In the embodiment, the projection unit 134 may include a projection lens module, a light source, a light valve and a driving circuit, etc., which is not limited by the invention. However, enough instructions, recommendations for implementation detail and the projection function of the projection unit 134 may be learned according to ordinary knowledge of the related technical field, and detail thereof is not repeated.

In the embodiment, the first electronic device 110 may further include an input device (not shown), and the input device is, for example, a keyboard, a mouse and a human-machine interface, etc. Alternatively, in an embodiment, the display device 114 is a touch display, and the user may operate the first electronic device 110 by touching the display device 114. To be specific, in the embodiment, the user may operate the first electronic device 110 to execute the interface editing module 111_1, so as to self-define the menu content of the OSD. After edition of the OSD is completed, the first electronic device 110 may output the interface editing data corresponding to the editing result to the projector 130, and the projector 130 sets the interface module 131_1 according to the interface editing data. Therefore, after the projector 130 is turned on, the projector 130 may project the image of the self-defined OSD.

For example, the user may edit a menu content, an interface style or a layout manner, etc. of the OSD, such that the menu content of the OSD projected by the projector may be presented according to user requirement or a projection environment. Moreover, the menu content may include a plurality of function menus, for example, an image brightness, an image contrast, an image color, an image aspect ratio or an image clarity, etc., which is not limited by the invention.

In an embodiment, the first electronic device 110 receives a first input signal coming from the input device to generate a corresponding first control signal. The first control signal is generated by the processing device 113 of the first electronic device 110. The first electronic device 110 outputs the first control signal to the projector 130 through the transmission module 112, and the projector 130 execute a first function adjusting operation on the OSD according to the first control signal. In detail, when the projector 130 projects the projection image according to the projection data, and when the user wants to execute the OSD, the projector 130 may integrate the integrate image data and the projection data to superimpose the OSD on the projection image. When the projector 130 receives the first control signal provided by the first electronic device 110, the projector 130 executes the first function adjusting operation on the OSD according to the first control signal, for example, an operation of adjusting an image brightness or contrast in the function options, though the invention is not limited thereto. Namely, besides that the user may edit the OSD by viewing the display device 114 of the first electronic device 110, the user may also view the OSD projected on a projection plane by the projector 130 through the first electronic device 110, so as to edit the OSD through the first electronic device 110. Therefore, the user may operate the function menu of the projector 130 through the input device of the first electronic device 110, where the projection data may be provided by the first electronic device 110 or other image source, which is not limited by the invention. In the embodiment, the OSD displayed on the display device 114 of the first electronic device 110 is consistent with the OSD projected on the projection surface by the projector 130.

In the embodiment, the storage devices 111, 131 may be respectively any type of a fixed or movable random access memory (RAM), a read-only memory (ROM), a flash memory, or a similar device or a combination of the above devices. The storage device 111 and the storage device 131 are used for storing modules and data mentioned in various embodiments of the invention, and the processing devices 113 and 133 may respectively execute the modules to implement data processing and the projection method of various embodiments of the invention.

In the embodiment, the transmission module 112 and 132 may be respectively a wired transmission module or a wireless transmission module, for example, a local area network (LAN), an optical fiber, devices supporting a communication protocol of wireless fidelity (Wi-Fi), worldwide interoperability for microwave access (WiMAX), bluetooth, ultra-wideband (UWB) or radio-frequency identification (RFID), etc. One of the transmission modules 112 and 132 may send a transmission signal to establish a communication link with the other one of the transmission modules 112 and 132.

In the embodiment, the processing devices 113 and 133 are, for example, central processing units (CPU) having an image data processing function and a computation function, or other programmable general purpose or special purpose microprocessors, digital signal processors (DSP), image processing units (IPU), graphics processing unit (GPU), programmable controllers, application specific integrated circuits (ASIC), programmable logic devices (PLD) or other similar processing devices or a combination of the above devices.

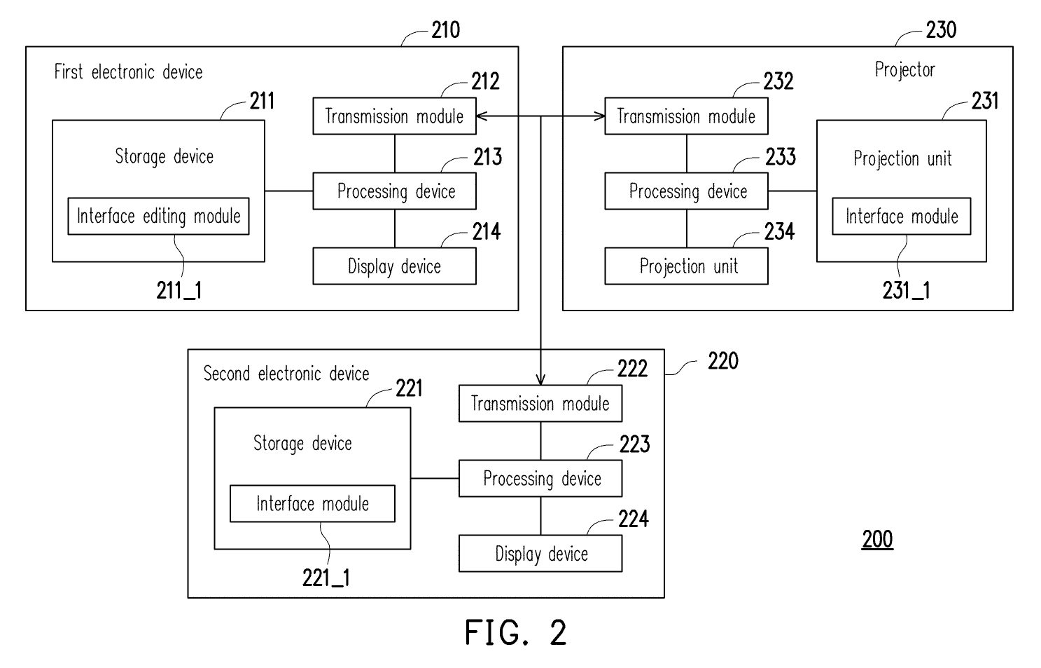

FIG. 2 is a schematic diagram of a projection system according to another embodiment of the invention. Referring to FIG. 2, in the embodiment, the projection system 200 includes a first electronic device 210, a second electronic device 220 and a projector 230. The first electronic device 210 includes a storage device 211, a transmission module 212, a processing device 213 and a display device 214. The second electronic device 220 includes a storage device 221, a transmission module 222, a processing device 223 and a display device 224. The projector 230 includes a storage device 231, a transmission module 232, a processing device 233 and a projection unit 234.

In the embodiment, the first electronic device 210 is, for example, a desktop computer or a personal computer (PC), etc. The first electronic device 210 may be used for editing an OSD, and outputting interface editing data of the edited OSD. In the embodiment, the second electronic device 220 is, for example, a portable electronic device such as a portable terminal product, a personal digital assistor (PDA) or a smart phone, etc. The second electronic device 220 may be installed with applications (APP) or corresponding execution software adapted to the projector 230, so that the user may operate the second electronic device 220 to control a function menu in an image of the OSD projected by the projector 230 in remote control. In the embodiment, the first electronic device 210, the second electronic device 220 and the projector 230 are respectively connected to each other through the transmission modules 212, 222, 232 for communication.

In the embodiment, the processing device 213 of the first electronic device 210 is coupled to the storage device 211. The processing device 213 is used for executing an interface editing module 211_1 to edit the OSD. The processing device 213 transmits the interface editing data of the edited OSD to the second electronic device 220 and the projector 230 through the transmission module 212, such that the second electronic device 220 and the projector 230 may set interface modules 221_1 and 231_1 according to the interface editing data. Namely, in the embodiment, the user may operate the first electronic device 210 to edit the OSD, and outputs the interface editing data corresponding to the editing result to the second electronic device 220 and the projector 230. Therefore, the interface modules 221_1 and 231_1 of the second electronic device 220 and the projector 230 may generate the corresponding OSD according to the interface editing data transmitted by the first electronic device 210, and the display device 224 of the second electronic device 220 may display the OSD and the projection unit 234 of the projector 230 projects the same OSD.

To be specific, the user may use the first electronic device 210 to execute the interface editing module 211_1, so as to set the menu content of the OSD. After edition of the OSD is completed, the first electronic device 210 outputs the interface editing data corresponding to the editing result to the second electronic device 220 and the projector 230, such that the second electronic device 220 and the projector 230 may set the interface modules 221_1, 231_1 according to the interface editing data. Therefore, after the projector 230 is turned on, the projector 230 may project the image of the user-defined OSD, and the user may view the image of the same OSD from the display device 224 of the second electronic device 220.

In the embodiment, the display device 224 is, for example, a touch display, so that the user may operate the second electronic device 220 in a way of touching the display device 224, and the second electronic device 220 receives a second input signal coming from the touch display device 224 to correspondingly generate a second control signal, where the second control signal is generated by the processing device 223. In the embodiment, the second electronic device 220 outputs the second control signal to the projector 230 through the transmission module 222, and the projector 230 executes a second function adjusting operation on the OSD projected by the projector 230 according to the second control signal.

In an embodiment, the display device 224 of the second electronic device 220 may also display an adjusting icon, and the user may operate the second electronic device 220 through the touch display device 224 according to the adjusting icon displayed by the display device 224, such that the second electronic device 220 correspondingly generate a third control signal according to a received third input signal.

In the embodiment, the second electronic device 220 outputs the third control signal to the projector 230 through the transmission module 222, and the projector 230 executes a third function adjusting operation on the OSD projected by the projector 230 according to the third control signal.

Moreover, enough instructions and recommendations for other device features, module features and implementation methods of the first electronic device, the second electronic device and the projector may be learned by referring to the embodiment of FIG. 1, and detail thereof is not repeated.

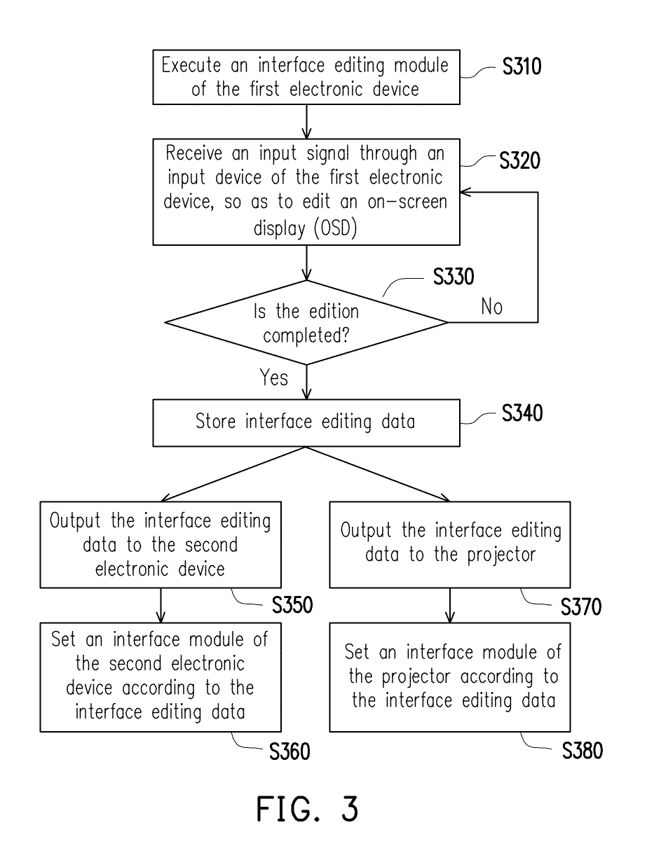

FIG. 3 is a flowchart illustrating a method for editing an OSD according to an embodiment of the invention. Referring to FIG. 2 and FIG. 3, the method for editing the OSD of FIG. 3 is adapted to the projection system 200 of the embodiment of FIG. 2, in step S310, the first electronic device 210 executes the interface editing module 211_1. In step S320, the first electronic device 210 receives an input signal through an input device, so as to edit the OSD. In step S330, if the edition is not completed, the first electronic device 210 continually executes the step S320. If the edition is completed, the first electronic device 210 executes a step S340. In the step S340, the first electronic device 210 stores the interface editing data in the storage device 111_1 according to the editing result of the OSD. In step S350 and step S370, the first electronic device 210 respectively outputs the interface editing data to the second electronic device 220 and the projector 230. In step S360 and step S380, the second electronic device 220 and the projector 230 respectively set the interface modules 221_1 and 231_1 according to the interface editing data. Therefore, the second electronic device 200 and the projector 230 may synchronously display the images of the same OSD.

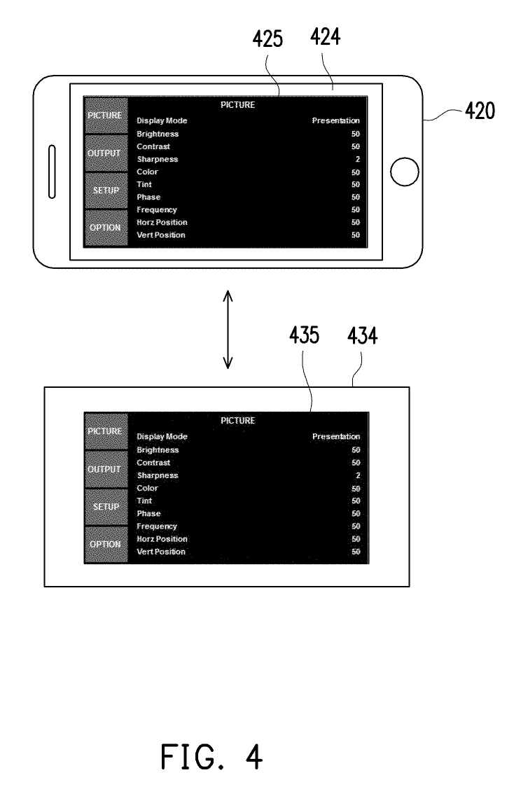

FIG. 4 is a schematic diagram of an OSD according to an embodiment of the invention. Referring to FIG. 4, in the embodiment, after edition of the OSD is completed, the first electronic device outputs the interface editing data corresponding to the editing result to the second electronic device 420 and the projector, such that a display device 424 of the second electronic device 420 may display an OSD 425, and a projection image 434 projected on the projection surface by the projector includes an OSD 435. In other words, the OSD 435 is superimposed on the projection image 434. In the embodiment, the OSD 425 displayed by the second electronic device 420 is the same to the OSD 435 in the projection image 434 projected by the projector. Namely, the user may view the OSD 425 through the display device 424 of the second electronic device 420, and the user may operate the projector by touching the display device 424 of the second electronic device 420, so as to control the function menu in the image of the OSD projected by the projector in remote control.

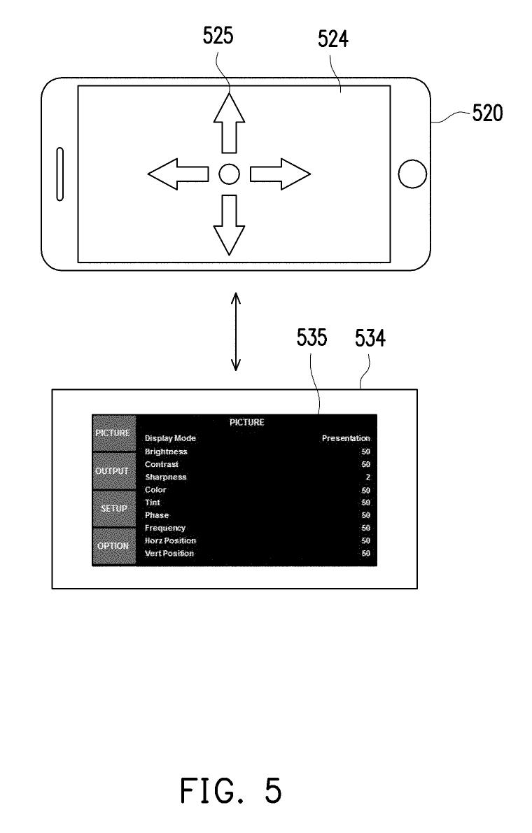

FIG. 5 is a schematic diagram of an OSD according to another embodiment of the invention. Referring to FIG. 5, in the embodiment, when edition of the OSD is completed, the first electronic device may output the interface editing data corresponding to the editing result to the second electronic device 520 and the projector, such that the display device 524 of the second electronic device 520 may display an adjusting tool interface 525, and a projection image 534 projected by the projector includes an OSD 535. In other words, the OSD 535 is superimposed on the projection image 534. In the embodiment, the adjusting tool interface 525 displayed by the second electronic device 520 includes a plurality of adjusting icons. The second electronic device 520 may generate a corresponding control signal according to a touch result exerted on the adjusting icons by the user. Therefore, the user may operate the projector by touching the display device 524 of the second electronic device 520, so as to control the function menu in the image of the OSD projected by the projector in remote control. However, a pattern of the adjusting icons on the adjusting tool interface 525 of the invention is not limited to FIG. 5.

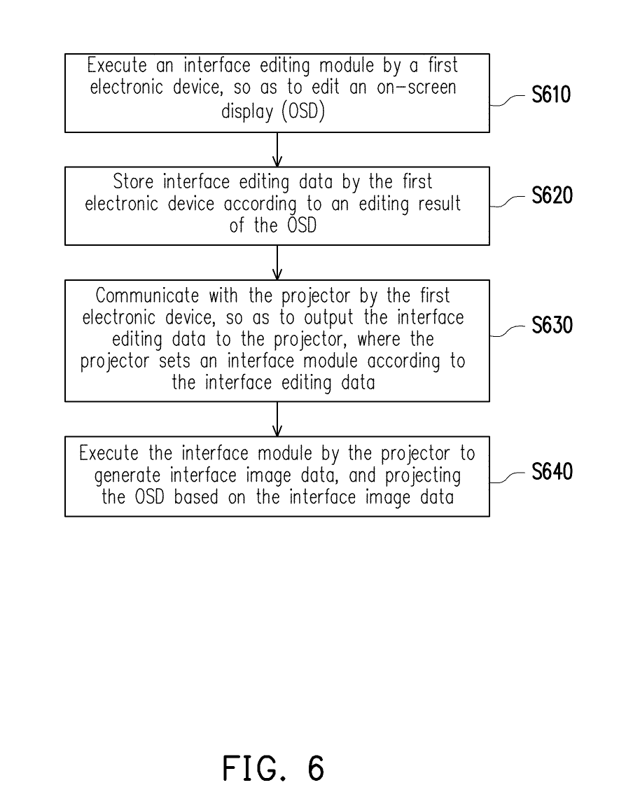

FIG. 6 is a flowchart illustrating a projection method according to an embodiment of the invention. Referring to FIG. 1 and FIG. 6, the projection method of the embodiment is adapted to the projection system 100 of FIG. 1. In step S610, the first electronic device 110 executes the interface editing module 111_1 to edit an OSD. In step S620, the first electronic device 110 stores interface editing data to the storage device 111 according to an editing result of the OSD. In step S630, the first electronic device 110 communicates with the projector 130 to output the interface editing data to the projector 130, where the projector 130 sets the interface module 131_1 according to the interface editing data. In step S640, the projector 130 executes the interface module 131_1 to generate interface image data, and projects the OSD based on the interface image data. Therefore, the OSD projected by the projector 130 may be pre-edited on the first electronic device 110, and the interface editing data produced after the edition is provided to the projector 130, such that the menu content of the OSD projected by the projector 130 may be determined according to a usage requirement or a projection environment.

Moreover, enough instructions and recommendations for other device features and implementation methods of the first electronic device and the projector may be learned by referring to the embodiment of FIG. 1, and detail thereof is not repeated.

In summary, the projection method and the projection system of the invention provide a function of editing the OSD, so that the user may edit the OSD by the first electronic device. Then, the first electronic device outputs the interface editing data corresponding to the editing result to the projector, and the projector projects the user-defined OSD. Moreover, the projection method and the projection system of the invention may also output the interface editing data to the second electronic device, so as to operate the projector by the second electronic device, where the second electronic device is, for example, a portable electronic device. Therefore, the user may view the same OSD through the second electronic device, and may operate the function menu of the projector in remote control by the second electronic device.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims.

What is claimed is:

1. A projection method, adapted to a projector, the projection method comprising:
executing an interface editing module by a first electronic device, so as to edit an on-screen display;
storing interface editing data by the first electronic device according to an editing result of the on-screen display;
communicating with the projector by the first electronic device, so as to output the interface editing data to the projector;
setting a first interface module by the projector according to the interface editing data; and
executing the first interface module by the projector to generate interface image data, and projecting the on-screen display based on the interface image data.

2. The projection method of claim 1, further comprising:
receiving a first input signal by the first electronic device to generate a first control signal; and
outputting the first control signal to the projector, and executing a first function adjusting operation on the on-screen display projected by the projector according to the first control signal.

3. The projection method of claim 1, further comprising:
projecting a projection image based on projection data; and
integrating the interface image data and the projection data to superimpose the on-screen display on the projection image.

4. The projection method of claim 1, wherein the interface editing module stores the interface editing data in a preset encoding manner, and the interface editing data comprises text data and image data.

5. The projection method of claim 1, further comprising:
communicating with the second electronic device by the first electronic device to output the interface editing data to the second electronic device, wherein the second electronic device sets a second interface module according to the interface editing data.

6. The projection method of claim 5, further comprising:
receiving a second input signal by the second electronic device, so as to correspondingly generate a second control signal;
communicating with the projector by the second electronic device; and
outputting the second control signal to the projector, and executing a second function adjusting operation on the on-screen display projected by the projector according to the second control signal.

7. The projection method of claim 5, further comprising:
receiving a third input signal by the second electronic device, so as to correspondingly generate a third control signal;
communicating with the projector by the second electronic device; and
outputting the third control signal to the projector, and executing a third function adjusting operation on the on-screen display displayed by the second electronic device according to the third control signal.

8. A projection system, comprising:
a first electronic device, comprising:
a storage device, configured to store an interface editing module;
a processing device, electrically connected to the storage device, and configured to execute the interface editing module to edit an on-screen display, and store interface editing data to the storage device according to an editing result of the on-screen display; and
a transmission module, electrically connected to the processing device, and configured to output the interface editing data; and
a projector, communicating with the first electronic device, and comprising:
a transmission module, configured to receive the interface editing data output by the first electronic device;
a storage device, having a first interface module, and setting the first interface module according to the interface editing data;
a processing device, electrically connected to the transmission module and the storage device, and configured to execute the first interface module to generate interface image data; and
a projection unit, electrically connected to the processing device, and configured to project the on-screen display, wherein the on-screen display is projected according to the interface image data.

9. The projection system of claim 8, wherein the first electronic device receives a first input signal to generate a first control signal, and the first electronic device outputs the first control signal to the projector,
wherein the projector executes a first function adjusting operation on the on-screen display according to the first control signal.

10. The projection system of claim 8, wherein the projector is further configured to project a projection image based on projection data, and integrate the interface image data and the projection data to superimpose the on-screen display on the projection image.

11. The projection system of claim 8, wherein the interface editing module stores the interface editing data in a preset encoding manner, and the interface editing data comprises text data and image data.

12. The projection system of claim 8, further comprising:
a second electronic device, communicating with the first electronic device to output the interface editing data to the second electronic device, wherein the second electronic device sets a second interface module according to the interface editing data.

13. The projection system of claim 12, wherein the second electronic device receives a second input signal to correspondingly generate a second control signal, and the second electronic device communicates with the projector to output the second control signal to the projector,
wherein the projector executes a second function adjusting operation on the on-screen display according to the second control signal.

14. The projection system of claim 12, wherein the second electronic device receives a third input signal to correspondingly generate a third control signal, and the second electronic device communicates with the projector to output the third control signal to the projector,
wherein the second electronic device executes a third function adjusting operation on the on-screen display displayed by the second electronic device according to the third control signal.

15. A projector, configured to communicate with a first electronic device, comprising:
a transmission module, configured to receive interface editing data output by the first electronic device;
a storage device, having a first interface module, and setting the first interface module according to the interface editing data a processing device, electrically connected to the transmission module and the storage device, and configured to execute the first interface module to generate interface image data; and
a projection unit, electrically connected to the processing device, and configured to project an on-screen display, wherein the on-screen display is projected according to the interface image data.
